(19) United States
(12) Patent Application Publication
(10) Pub. No.: US 2006/0010772 A1
(43) Pub. Date: Jan. 19, 2006

(54) Path-controlled window lifter for motor vehicles

(76) Inventors: Frank Fassbender, Coburg (DE); Wolfgang Wachter, Burkersdorf (DE)

Correspondence Address: CHRISTIE, PARKER & HALE, LLP, PO BOX 7068, PASADENA, CA, 91109-7068, US

(21) Appl. No.: 11/180,312

(22) Filed: Jul. 12, 2005

(30) Foreign Application Priority Data
Jul. 13, 2004 (DE) 20 2004 010 955.7

(51) Int. Cl. E05F 11/38

(52) U.S. Cl. 49/348; 49/349

(57) ABSTRACT

The invention relates to a path-guided window lifter for a motor vehicle, with a guideway in a guide plate, two slide elements interacting with the upper and lower side of the guide plate for guiding the follower perpendicular to the surface of the guide plate and with an additional slide element which interacts through slide faces with opposite flanks of the guideway and guides the follower in the surface of the guide plate. The object of the present invention is to develop a window lifter of this kind so that increased wear on the slide block can be counteracted. The slide faces are attached spring-elastically to the additional slide element.

### CROSS-REFERENCE TO RELATED APPLICATION

This application claims priority of German Utility Model Application Number 20 2004 010 955.7, filed on Jul. 13, 2004.

### BACKGROUND

The invention relates to a path-controlled window lifter for a motor vehicle.

Path-controlled cable window lifters have two or more guideways stamped into a sheet metal plate and each holding a follower which is capable of sliding movement. The followers support the window pane which is to be raised and lowered through a retaining rail. A window lifter of this kind is shown in DE 202 12 774 U1.

With this known window lifter three guideways are provided in a guide plate wherein each guideway has two guide webs running parallel to each other through the stamping process. The multi-part follower consists of an upper and a lower slide element which are connected together through a bolt and spring element (plate spring). The slide elements interact with the upper and lower side of the guide plate and thus produce the guide for the follower perpendicular to the plane of the guide plate—this direction is designated the Y-direction in the case of a window lifter of a side window (vehicle door).

The guidance of the follower in the plane of the guideway, thus perpendicular to its direction of movement—the X-direction is undertaken by a further slide element in the form of a slide block which fits with precision between the guide webs and which interacts by its two outer sides with the flanks of the guide webs.

In the case of a window lifter having three guideways the situation is over-defined. As a result of manufacturing tolerances there is always a forced action—the slide block which produces the defined fit is subject to increased friction which produces heavy going and heavier wear. Thus in time play occurs which prevents precision guiding and positioning of the window pane.

Even with path-controlled window lifters with two guideways tolerances mean increased friction and wear-inducing forces in the region of the slide block and guideway.

### BRIEF DESCRIPTION

The object of the present invention is therefore to further develop a path-guided window lifter with a view to improving its functioning.

It is proposed that the slide block has elasticity on the sides interacting with the flanks of the guide webs. This elasticity compensates position tolerances of the guideways—increased wear is counteracted.

According to an embodiment of the invention it is proposed that the slide block is made from a wear-resistance material having good sliding properties, preferably plastics. The regions of the outer sides of the slide block which interact with the guide webs of the guideway are filled with a material producing elasticity. Thus a pliability is produced with sliding properties which are as good as if the slide block were made only of this material.

The elasticity of the slide block in the proposed regions can also be achieved through shaping the slide block body. Thus it is possible to design the regions underneath the sides of the slide block interacting with the guide webs to be hollow and thus to provide elasticity in the manner of a leaf spring.

The slide element can also be made up in many pieces instead of as a one-piece slide block. Thus slide elements interacting with the guide webs can be provided which are supported through spring elements. Even with such a design of the invention tolerance compensation is produced through the pliability which is achieved. Running defects of the window lifter are lower and the system has an overall easy action.

### BRIEF DESCRIPTION OF THE DRAWINGS

The invention will now be explained in further detail with reference to an embodiment illustrated in the drawings.

FIG. 1 shows a view of the follower;

FIG. 2 shows a perspective view of the slide block;

FIG. 3 shows a section through the follower and slide block;

FIG. 4 shows a section on an enlarged scale through the slide block;

FIG. 5 shows a plan view of the slide block and

FIG. 6 shows a window lifter having three guideways.

### DETAILED DESCRIPTION

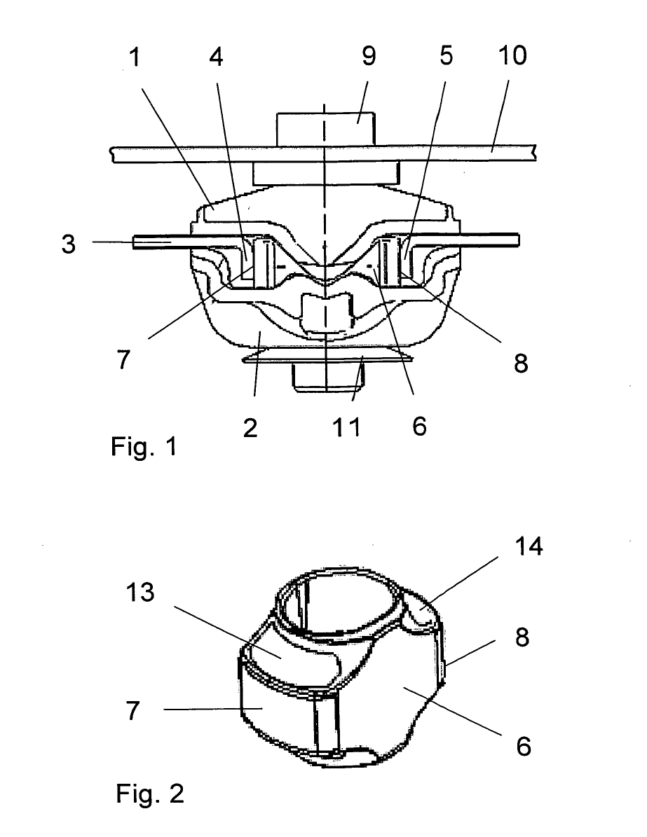

FIG. 1 shows a follower in a view towards the guideway (Z-direction). The follower consists of an upper and lower slide element 1, 2 which interact with the upper and lower side of a guide plate 3 which is made from a stamped sheet metal plate. In the region of the guideway two guide webs 4,5 are shaped round perpendicular to the guide plate 3 (through a stamping process) and thus produce a guide channel with two opposite parallel flanks.

Between the slide elements 1, 2 which are made from a slidable plastics or are coated with a slideable plastics is inserted a slide block 6 which is in play-free contact by its two outer sides forming its slide faces 7, 8 with the flanks of the guide webs 4, 5. The two slide elements 1, 2 as well as the slide block 6 are connected to a bolt 9 and a plate spring 11. The two slide elements 1, 2 can compensate for any irregularities/thickness tolerances in the guide plate 3 through the plate spring 11. At one end of the bolt 9 is a fixed retaining rail 10 which supports a window pane (not shown).

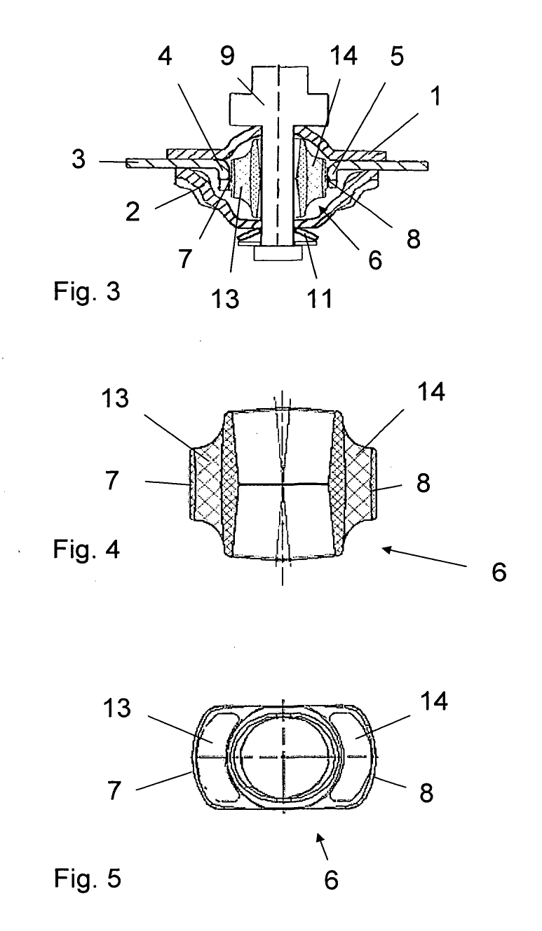

FIG. 3 shows in a sectional view the follower according to the invention next to the slide block 6. The bolt 9 engages through the two slide elements 1, 2 which are designed as moulded parts, as well as through the slide block 6. The elastic coupling between the upper and lower slide element 1, 2 is produced through the plate spring 11.

FIG. 4 shows in an enlarged sectional view the slide block 6 according to FIG. 3. The through opening for the bolt is shaped tapering conically from its two sides and surrounds the bolt 9 in the region of the smallest diameter without play—thus allowing the bolt 9 to tilt relative to the slide block 6. The bolt 8 is thus mounted movable within a maximum angle about a point in the centre of the through opening (of the slide block 6).

The slide faces 7, 8 of the slide block which interact with the guide webs 4, 5 which are not shown in FIGS. 4 and 5 are designed elastically pliable. According to this embodiment this is achieved in that the region of the slide block 6 lying underneath the slide faces 7, 8 is filled with an elastically pliable material—soft region 13, 14. The slide block 6 itself consists of a hard plastics material with good sliding properties—hard region 12. FIG. 5 shows the slide block 6 in a view from above—FIG. 2 in a perspective view.

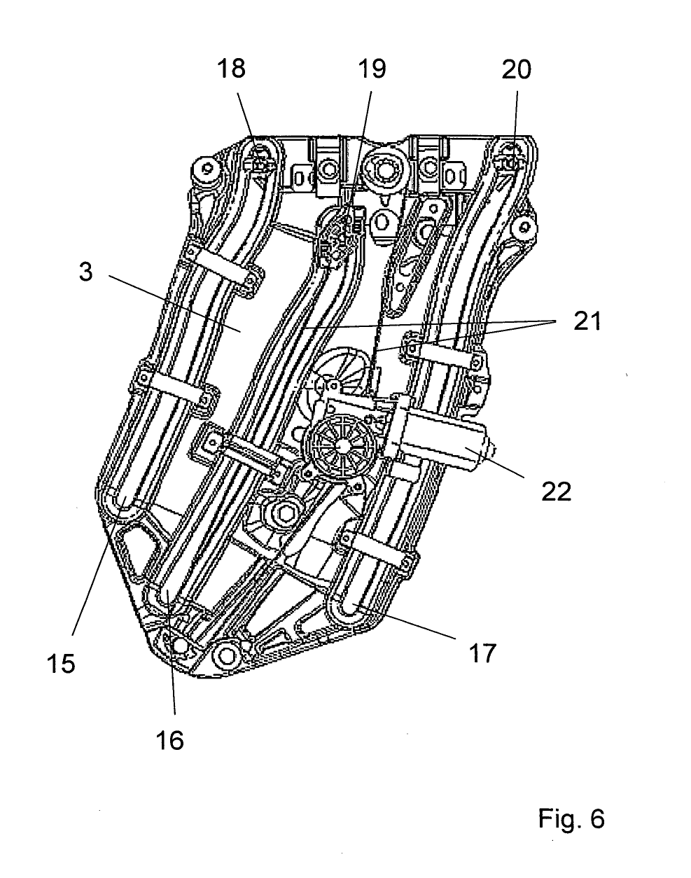

FIG. 6 shows a path-controlled window lifter which is known per se. This consists of a guide plate 3 in which three guideways 15, 16, 17 are stamped. A follower 18, 19, 20 constructed in principle as described above runs in each of these guideways 15, 16, 17. These followers are of identical construction whereby only one of the followers 18, 19, 20 has the elastic slide block 6—the other followers 18, 19, 20 are fitted with a non-flexible slide block of hard sliding material. The centre follower 19 can be driven by an electric motor 22 through a cable pulley system 21. The two other followers 18, 20 are moved along through the retaining rail which is not shown.

1. A path-guided window lifter for motor vehicle, with a guideway in a guide plate, two slide elements interacting with the upper and lower side of the guide plate for guiding the follower perpendicular to the face of the guide plate and with an additional slide element which interacts through slide faces with opposite flanks of the guideway and guides the follower in the surface of the guide plate, wherein the slide faces are attached with spring elastic tension on the additional slide element.

2. The path-guided window lifter according to claim 1, wherein the additional slide element is designed as a slide block with elastically pliable slide faces.

3. The path-guided window lifter according to claim 1, wherein the slide faces are connected to the additional slide element through spring elements.

4. The path-guided window lifter according to claim 2, wherein the slide block has underneath the slide faces soft regions with an elastically pliable material.

5. The path-guided window lifter according to claim 2, wherein the slide block has recesses producing spring-elastic properties in the slide faces.

6. The path-guided window lifter according to claim 1, wherein with a window lifter having several guideways at least one of the followers has an additional slide element which has spring-elastic slide faces.
